(19) United States
(12) Patent Application Publication
(10) Pub. No.: US 2004/0170326 A1
(43) Pub. Date: Sep. 2, 2004

(54) Image-processing method and image processor

(76) Inventors: Tomonori Kataoka, Oonojyo (JP); Satoshi Kajita, Yukuhashi (JP); Ikuo Fuchigami, Kasuya-Gun (JP); Kazuyuki Imagawa, Fukuoka (JP); Katsuhiro Iwasa, Iizuka (JP)

Correspondence Address: WENDEROTH, LIND & PONACK, L.L.P., 2033 K STREET N. W., SUITE 800, WASHINGTON, DC, 20006-1021, US

(21) Appl. No.: 10/762,281

(22) Filed: Jan. 23, 2004

(30) Foreign Application Priority Data
Jan. 27, 2003 (JP) 2003-017939

(51) Int. Cl. G06K 9/62; H04N 5/14

(52) U.S. Cl. 382/209; 348/208.4; 348/699

(57) ABSTRACT

A domain of an object detected by template matching is tracked in accordance with information on a motion vector that is included in compressed and encoded data. This feature eliminates template matching-based object detection when it comes to a motion vector information-containing image subject to object detection. As a result, object detection is achievable with a less amount of processing, when compared with the template matching-based detection of objects in all images subject to object detection.

### BACKGROUND OF THE INVENTION

1. Field of the Invention

The present invention relates to an image-processing method for detecting an object in an input image, and an image processor based thereon.

2. Description of the Related Art

There has been known a prior art that includes steps of pre-registering a template image, performing pattern matching between an input image and the template image, and detecting a position where an image similar to the template image is located in the input image.

However, an error in the detection is likely to often occur, depending upon the background of the image similar to the template image. An improved art that has overcome such a drawback is disclosed by the published Japanese Patent Application Laid-Open No. 5-28273. According to the improved art, a similarity value between the template image and an image corresponding to the template image is defined by the following formula:

$$\begin{matrix}{σ}_{s0} = \sqrt{\frac{1}{MN} {\sum }_{i = 1}^{M} {\sum }_{j = 1}^{N} ( {Sx}_{ij }^{2} + {Sy}_{ij}^{2} )} \\ {σ}_{T0} = \sqrt{\frac{1}{MN} {\sum }_{i = 1}^{M} {\sum }_{j = 1}^{N} ( {Tx}_{ij}^{2} + {Ty}_{ij}^{2} )} \\ {ρ}_{v0} = \frac{1}{MN} {\sum }_{i = 1}^{M} {\sum }_{j = 1}^{N} ( {Tx}_{ij} {Sx}_{ij} + {Ty}_{ij} {Sy}_{ij} ) \\ Cv = \frac{{ρ}_{v0}}{{σ}_{T0} {σ}_{s0}}\end{matrix} \\ \begin{matrix}Cv : & \text{correlation coefficient (value of similarity)} \\ M : & \text{number of pixels in} \text{x} \text{-direction for template image} \\ N : & \text{number of pixels in} \text{y} \text{-direction for template image} \\ Sx : & \text{differential value in} \text{x} \text{-direction for first image} \text{S} \\ Sy : & \text{differential value in} \text{y} \text{-direction for the first image} \text{S} \\ Tx : & \text{differential value in} \text{x} \text{-direction for the first image} \text{T} \\ Ty : & \text{differential value in} \text{y} \text{-direction for the first image} \text{T}\end{matrix} \qquad [ Formula 1 ]$$

More specifically, an inner product (cos Θ) of an angle (Θ) formed between an edge normal vector of a template image and that of an input image is viewed as a component of the similarity value.

In object detection based on the template-matching method, however, pixel data such as a luminance signal or a chroma signal are treated as input. In order to process an image encoded and compressed by MPEG, the image must experience template matching for each frame after being decoded. Such a disadvantage causes a problem of an inevitable increase in amount of processing.

### OBJECTS AND SUMMARY OF THE INVENTION

In view of the above, an object of the present invention is to provide an image-processing method for detecting an object in a moving picture in general with an extremely suppressible amount of processing.

A first aspect of the present invention provides an image-processing method designed for object detection in a moving image, comprising: detecting an object in a moving image by matching a template image with an image subject to object detection; and determining an amount of displacement of the detected object in accordance with information on a motion vector of an encoded moving image, the detected object being the object detected by the detecting the object by matching the template image with the image subject to object detection.

According to the above system, an amount of displacement of an object is determined in accordance with motion vector information, and the object can be tracked.

This feature eliminates template matching-based object detection when it comes to a motion vector information-containing image subject to object detection.

As a result, object detection is achievable with a less amount of processing, when compared with the template matching-based detection of objects in all images subject to object detection.

A second aspect of the present invention provides the image-processing method as defined in the first aspect of the present invention, wherein an object in an intra-coded picture (I-picture) is detected by the detecting the object by matching the template image with the image subject to object detection, wherein an object in a forward predictive picture (P-picture) is detected by the determining the amount of displacement of the detected object in accordance with information on the motion vector of the encoded moving image, the detected object being the object detected by the detecting the object by matching the template image with the image subject to object detection, and wherein an object in a bi-directionally predictive picture (B-picture) is detected by the determining the amount of displacement of the detected object in accordance with information on the motion vector of the encoded moving image, the detected object being the object detected by the detecting the object by matching the template image with the image subject to object detection.

Pursuant to the above system, in all motion vector information-containing images subject to object detection, an amount of displacement of an object is determined in accordance with motion vector information, thereby tracking the object. This feature realizes object detection with a further less amount of processing.

A third aspect of the present invention provides the image-processing method as defined in the first aspect of the present invention, further comprising: counting the number of frames in which an object is tracked by the determining the amount of displacement of the detected object in accordance with information on the motion vector of the encoded moving image, the detected object being the object detected by the detecting the object by matching the template image with the image subject to object detection; and, comparing a reference frame number with the number of the frames counted by the counting the number of the frames in which the object is tracked, wherein when the number of the frames counted by the counting the number of the frames in which the object is tracked is greater than the reference frame number, then object detection is performed by the detecting the object by matching the template image with the image subject to object detection.

This feature resets an accumulated error due to motion vector information-based object tacking, and provides improved accuracy of detection.

A fourth aspect of the present invention provides the image-processing method as defined in the first aspect of the present invention, wherein the detecting the object by matching the template image with the image subject to object detection comprises: comparing a reference value with a similarity value between the template image and the image subject to object detection; and employing results from the detection of an object in at least one frame behind when the similarity value is smaller than the reference value, in order to practice object detection in an intra-coded picture (I-picture).

This feature makes it feasible to predict a position of an object in accordance with results from the detection of another object in one frame behind, even in failure of template matching-based object detection.

A fifth aspect of the present invention provides the image-processing method as defined in the first aspect of the present invention, further comprising: decoding an encoded moving image, thereby generating the image subject to object detection; editing the image subject to object detection as a first image; and composing the edited first image with a second image, thereby producing a composed image, wherein the detecting the object by matching the template image with the image subject to object detection includes providing information on a position of a detected object, wherein the determining the amount of displacement of the detected object in accordance with information on the motion vector of the encoded moving image, the detected object being the object detected by the detecting the object by matching the template image with the image subject to object detection includes providing information on a position of a displaced object, and wherein the editing the image subject to object detection as the first image includes editing the first image in accordance with the information on the position.

This feature edits an object to be detected (e.g., the centering of the object), even when the object is displaced from the center of the first image. Consequently, the edited first image is successfully composed with the second image.

A sixth aspect of the present invention provides the image-processing method as defined in the first aspect of the present invention, further comprising: detecting a scene change in the image subject to object detection, wherein an object in the image subject to object detection in which a scene has been changed is detected by the detecting the object by matching the template image with the image subject to object detection.

According to the above system, an object in an I-picture containing null motion vector is detectable.

A seventh aspect of the present invention provides an image-processing method comprising: detecting any object in a moving image; editing the moving image in accordance with information on a position of the detected object; composing the edited moving image with another moving image; and encoding and compressing the composed image.

This feature edits an object to be detected (e.g., the centering of the object), even when the object is displaced from the center of the moving image. Consequently, the edited image is successfully composed with another moving image.

An eight aspect of the present invention provides the image-processing method as defined in the first aspect of the present invention, wherein the object to be detected is a human face.

According to the above system, a human face (an object) is detectable with a less amount of processing, when compared with the template matching-based detection of the human face (object) in all images subject to object detection.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating an image processor according to a first embodiment of the present invention;

FIG. 2 is a block diagram illustrating a decoding unit according to the first embodiment;

FIG. 3 is a block diagram illustrating an object-detecting unit according to the first embodiment;

FIG. 4(a) is an illustration showing an example of a template image according to the first embodiment;

FIG. 4(b) is an illustration showing an example of an edge-extracted image (an x-component) of the template image according to the first embodiment;

FIG. 4(c) is an illustration showing an example of an edge-extracted image (a y-component) of the template image according to the first embodiment;

FIG. 5(a) is an illustration showing an example of a template image according to the first embodiment;

FIG. 5(b) is an illustration showing an example of another template image according to the first embodiment;

FIG. 6 is an illustration showing an example of how an object-tracking unit according to the first embodiment tracks an object domain;

FIG. 7 is an illustration showing an example of how a detection method-selecting unit according to the first embodiment deals with images;

FIG. 8 is a block diagram illustrating an image processor according to a second embodiment; and

FIG. 9 is an illustration showing steps of processing according to the second embodiment.

### DETAILED DESCRIPTION OF THE PREFERRED EMBODIMENTS

Hereinafter, a description is given of embodiments of the invention with reference to the accompanying drawings. In the embodiments, a human face is illustrated as an object to be detected.

(First Embodiment)

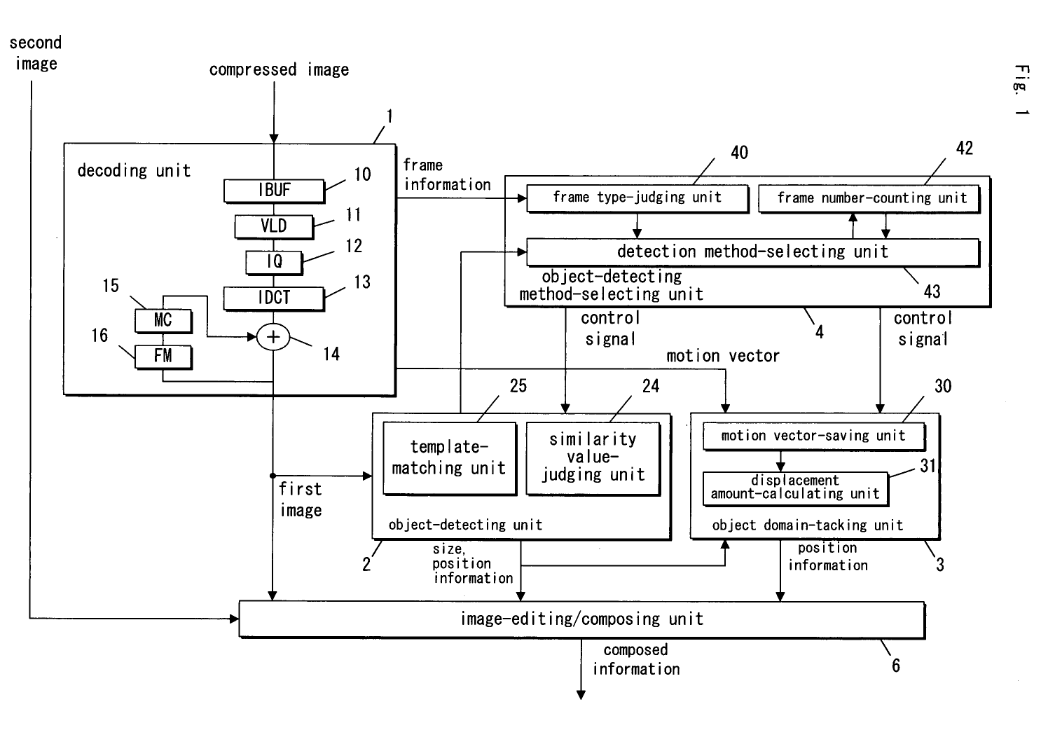

FIG. 1 is a block diagram illustrating an image processor according to a first embodiment of the present invention. As illustrated in FIG. 1, the image processor includes a decoding unit 1, an object-detecting unit 2, an object domain-tracking unit 3, an object-detecting method-selecting unit 4, and an image-editing/composing unit 6.

The decoding unit 1 includes an input buffer (IBUF) 10, a variable length-decoding unit (VLD) 11, an inverse quantizing unit (IQ) 12, an inverse discrete cosine-transforming unit (IDCT) 13, an adding unit 14, a motion-compensating unit (MC) 15, and a frame memory (FM) 16.

The object-detecting unit 2 includes a template-matching unit 25 and a similarity value-judging unit 24.

The object domain-tacking unit 3 includes a motion vector-saving unit 30 and a displacement amount-calculating unit 31.

The object-detecting method-selecting unit 4 includes a frame type-judging unit 40, a frame number-counting unit 42, and a detection method-selecting unit 43.

The following discusses briefly how the above components are operated.

The decoding unit 1 decodes an encoded and compressed image.

The object-detecting unit 2 detects an object in the decoded image in accordance with a template-matching method.

The object domain-tacking unit 3 tracks a domain of the detected object in accordance with motion vector information.

The object-detecting method-selecting unit 4 selects either the object-detecting unit 2 or the object domain-tacking unit 3.

The image-editing/composing unit 6 edits a first image in accordance with information on a position of the object. The information issues from either the object-detecting unit 2 or the object domain-tacking unit 3. The image-editing/composing unit 6 composes the edited first image with a second image.

The image-editing/composing unit 6 may use size information on the object when editing or composing the first image with the second image. The size information on the object comes from the object-detecting unit 2.

The following discusses details of behaviors of the above components.

The decoding unit 1 is now described.

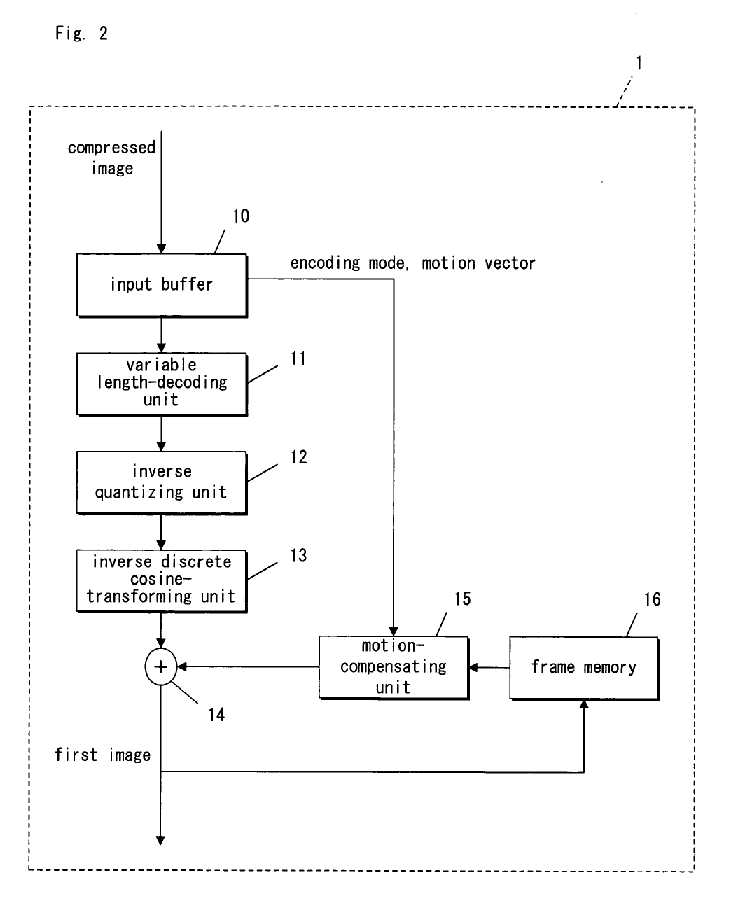

FIG. 2 illustrates a descriptive illustration showing the decoding unit 1. In FIG. 2, components similar to those of FIG. 1 are identified by the same reference numerals.

MPEG (Moving Picture Experts Group) is one of methods for encoding and compressing a digital image.

The MPEG performs intra-frame encoding in accordance with a spatial correlation established within one frame image.

In order to remove redundant signals between images, the MPEG performs motion compensation-based inter-frame prediction in accordance with a time correlation between frame images, and then performs inter-frame encoding to encode a differential signal.

The MPEG in combination of the intra-frame encoding and the inter-frame encoding realizes encoded data with a high-compression ratio.

To encode an image in accordance with the MPEG standard, an image value experiences orthogonal transformation, thereby providing an orthogonal transformation coefficient. The following description illustrates discrete cosine transformation (DCT) as an example of the orthogonal transformation. This means that a DCT coefficient is provided as a result of discrete cosine transformation.

The DCT coefficient is quantized with a predetermined width of quantization, thereby providing a quantized DCT coefficient.

The qunatized DCT coefficient experiences variable length coding, thereby producing encoded data, i.e., compressed image data.

In the decoder, or rather the decoding unit 1 as illustrated in FIG. 2, the input buffer 10 accumulates the compressed image data, i.e., the encoded data (bit streams).

The variable length-decoding unit 11 decodes the encoded data for each macro block, thereby separating the decoded data into several pieces of data: information on an encoding mode, motion vector information, information on quantization, and the quantized DCT coefficient.

The inverse quantizing unit 12 inversely qunatizes the decoded, quantized DCT coefficient for each macro block, thereby providing a DCT coefficient.

The inverse discrete cosine-transforming unit 13 performs the inverse discrete cosine transformation of the DCT coefficient, thereby transforming the DCT coefficient into spatial image data.

In an intra-encoding mode, the inverse discrete cosine-transforming unit 13 provides the spatial image data as such.

In a motion compensation prediction mode, the inverse discrete cosine-transforming unit 13 feeds the spatial image data into the adding unit 14.

The adding unit 14 adds the spatial image data with motion-compensated and predicted image data from the motion-compensating unit 15, thereby providing the added data.

The above steps are carried out for each macro block. Frame images are rearranged in proper sequence, thereby decoding output image frames or first images.

The frame memory 16 accumulates the first images, more specifically, pieces of picture information such as an I-picture (an Intra-Picture), a P-picture (a Predictive-Picture), and a B-picture (a Bi-directionally predictive-Picture). The motion-compensating unit 15 uses the accumulated first images or picture information as reference images.

The object-detecting unit 2 is now described. More specifically, object detection based on a template-matching method is described.

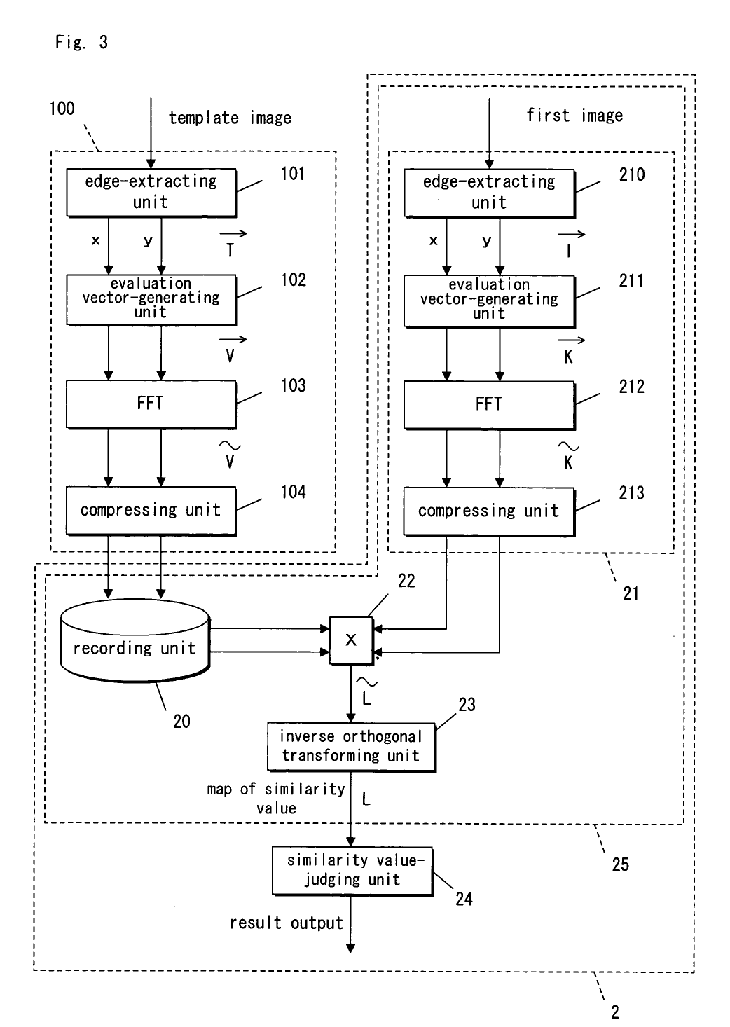

FIG. 3 is a block diagram illustrating the object-detecting unit 2 of FIG. 1. In FIG. 3, components similar to those of FIG. 1 are identified by the same reference numerals.

As illustrated in FIG. 3, the object-detecting unit 2 includes the template-matching unit 25 and the similarity value-judging unit 24.

The template-matching unit 25 includes a recording unit 20, an input image-processing unit 21, an integrating unit 22, and an inverse orthogonal transforming unit (inverse FFT) 23.

The input image-processing unit 21 includes an edge-extracting unit 210, an evaluation vector-generating unit 211, an orthogonal transforming unit (FFT) 212, and a compressing unit 213.

As illustrated in FIG. 3, the object-detecting unit 2 evaluates matching between a template image and the first image using a map of similarity value “L”. In both a template image-processing unit 100 and the input image-processing unit 21, orthogonal transformation having linearity is performed before integration, followed by inverse orthogonal transformation, with the result that similarity value “L” is obtained.

In the present embodiment, FFT (fast Fourier transformation) is employed as orthogonal transformation as given above. Alternatively, either Hartley transformation or arithmetic transformation is applicable. Therefore, the term “Fourier transformation” in the description below can be replaced by either one of the above alternative transformations.

Both of the template image-processing unit 100 and the input image-processing unit 21 produce edge normal direction vectors to obtain an inner product thereof. A higher correlation is provided when two edge normal direction vectors are oriented closer to one another. The inner product is evaluated in terms of even-numbered multiple-angle expression.

For convenience of description, the present embodiment illustrates only double angle expression as an example of the even-numbered multiple-angle expression. Alternatively, the use of other even-numbered multiple-angle expression such as 4-time angle expression and 6-time angle expression provides beneficial effects similar to those of the present invention.

The template image-processing unit 100 is now described. As illustrated in FIG. 3, the template image-processing unit 100 includes an edge-extracting unit 101, an evaluation vector-generating unit 102, an orthogonal transforming unit (FFT) 103, and a compressing unit 104.

The edge-extracting unit 101 differentiates (edge-extracts) a template image along x- and y-directions, thereby providing an edge normal direction vector of the template image.

In the present embodiment, a Sobel filter as given below is used in the x-direction.

$$[ \begin{matrix}- 1 & 0 & 1 \\ - 2 & 0 & 2 \\ - 1 & 0 & 1\end{matrix} ] \qquad [ Formula 2 ]$$

Another Sobel filter as given below is used in the y-direction.

$$[ \begin{matrix}- 1 & - 2 & - 1 \\ 0 & 0 & 0 \\ 1 & 2 & 1\end{matrix} ] \qquad [ Formula 3 ]$$

The use of the above filters determine an edge normal direction vector of the template image, as defined by the following formula:

\vec{T}=(Tₓ,T_{y}) [Formula 4]

The present embodiment assumes that a figure of a person in a certain posture, who is walking on a crossroad, is extracted from a first image that has photographed the crossroad and neighboring views.

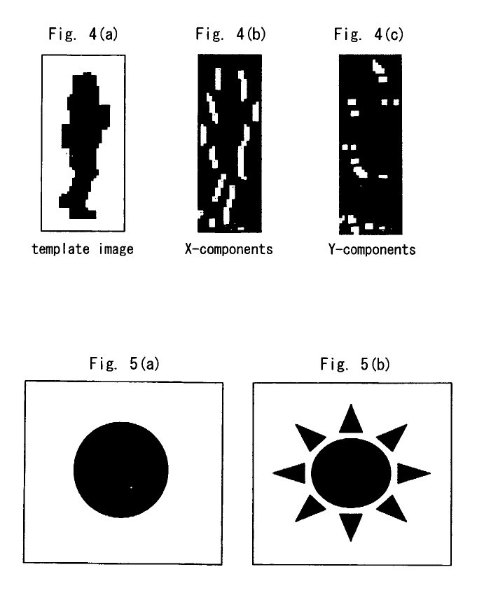

In this instance, a template image of the person is, e.g., an image as illustrated in FIG. 4(a). Filtering the template image of FIG. 4(a) in accordance with Formula 2 results in an image (x-components) as illustrated in FIG. 4(b). Filtering the template image of FIG. 4(a) in accordance with Formula 3 brings to an image (y-components) as illustrated in FIG. 4 (c).

The edge normal direction vector of the template image enters the evaluation vector-generating unit 102 from the edge-extracting unit 101. The evaluation vector-generating unit 102 processes the edge normal direction vector of the template image in a way as discussed below, thereby feeding an evaluation vector of the template image into the orthogonal transforming unit 103.

The evaluation vector-generating unit 102 normalizes in lenght the edge normal direction vector of the template image in accordance with a formula that follows:

[Formula 5]

$$\vec{U} = ( {U}_{X} , {U}_{Y} ) = \frac{\vec{T}}{\vert \vec{T} \vert}$$

In general, the intensity of edges of the first image is varied with photographic conditions. However, an angular difference between respective edges of the first image and the template image (or, a value of a dependant function, which monotonously changes with such an angular different) is resistant to change in response to the photographic conditions.

As discussed later, according to the present invention, the input image-processing unit 21 normalizes the edge normal vector of the first image to a length of unity. Accordingly, the template image-processing unit 100 normalizes the edge normal direction vector of the template image to a length of unity.

This system provides increased stability of pattern extraction. The normalized length of unity (or one) is usually considered to be better. Alternatively, other constants are available as a normalized length.

As widely known, a trigonometric function establishes a double angle formula that follows:

cos(2Θ)=2 cos(Θ)²−1

sin(2Θ)=2 cos(Θ)sin(Θ) [Formula 6]

The evaluation vector-generating unit 102 seeks an evaluation vector of the template image, as defined by the following formula:

assume that “a” is a threshold value to eliminate small edges, the evaluation vector \vec{V} for the template image is given,

if |\vec{T}|≧a

$$\begin{matrix}\vec{V} = ( {V}_{X} , {V}_{Y} ) = \frac{1}{n} ( cos ( 2 α ) , sin ( 2 α ) ) \\ = \frac{1}{n} ( 2 {U}_{X}^{2} - 1 , 2 {U}_{X} {U}_{Y} )\end{matrix}$$

else

\vec{V}=\vec{O}

where n is number of \vec{T} for

|\vec{T}|≧a [Formula 7]

Formula 7 is now explained. Vectors small than constant “a” are considered as zero vectors in order to remove noises.

The normalization performed by dividing x- and y-components of the above evaluation vector by “n” is now discussed.

In generally, a template image has any shapes, and includes edges having a variety of shapes. For example, one template as illustrated in FIG. 5(a) has fewer edges, while another template as shown in FIG. 5(b) has more edges than those of FIG. 5(a). The present embodiment provides normalization through division by “n”. This system successfully evaluates a similarity degree using the same measure regardless of whether the template image contains a large or small number of edges.

The normalization through division by “n” not always must be carried out, but can be omitted when only a single type of a template image is used, or when only template images having the same number of edges are used.

Published Japanese Patent Application No. 2002-304627 describes in detail the fact that the x- and y-components of Formula 7 are a subordinate function of double angle-related cosine and sine of x- and y-components of Formula 5; therefore, repeated description is omitted in the present embodiment.

Pursuant to the present invention, a similarity value is defined by a formula that follows:

[Formula 8 ]

value of similarity, L

$$\begin{matrix}L ( x , y ) = {\sum }_{i} {\sum }_{j} {K}_{X} ( x + i , y + j ) {V}_{X} ( i , j ) + \\ {K}_{Y} ( x + i , y + j ) {V}_{Y} ( i , j )\end{matrix}$$

\vec{K}=(K_{X}, K_{Y}): evaluation vector for the first image

\vec{V}=(V_{X}, V_{Y}): evaluation vector for the template image

Formula 8 is formed by only addition and multiplication, and a similarity value is linear in accordance with one evaluation vector of the first image and another of the template image. As a result, executing the Fourier-transformation of Formula 8 results in Formula 9 as give below in accordance with a discrete correlation theorem of Fourier transformation.

\tilde{L}(u,v)=\tilde{K}_{X}(u,v)\tilde{V}_{X}(u,v)*+\tilde{K}_{Y}(u,v)\tilde{V}_{Y}(u,v)* [Formula 9]

where the symbol [symbol] indicates a Fourier transformed value and the symbol [symbol] indicates a complex conjugate, and

\tilde{K}_{X}, \tilde{K}_{Y}: Fourier transformed values of Kx and Ky

\tilde{V}_{X}*, \tilde{V}_{Y}*: Fourier transformed complex conjugates of Vx and Vy

For the discrete correlation theorem of Fourier transformation, refer to “fast Fourier transformation”, translated by Yo MIYAGAWA, published by Kagaku Gijyutu Shuppansha.

Performing the inverse Fourier-transformation of Formula 9 provides the similarity value of Formula 8.

Subsequent components after the evaluation vector-generating unit 102 are now described. In the template image-processing unit 100 as illustrated in FIG. 3, the orthogonal transforming unit 103 perform the Fourier-transformation of the evaluation vector of the template image from the evaluation vector-generating unit 102. The Fourier-transformed evaluation vector of the template image is fed into the compressing unit 104.

The compressing unit 104 reduces the Fourier-transformed evaluation vector. The reduced evaluation vector is stored into the recording unit 20.

The compressing unit 104 may be omitted when the number of data of the Fourier-transformed evaluation vector is small, or when high speed processing is not required.

The input image-processing unit 21 is now described. The input image-processing unit 21 practices substantially the same processing as that of the template image-processing unit 100. More specifically, the edge-extracting unit 210 provides an edge normal direction vector of a first image based on the Formula 2 and Formula 3. Such an edge normal direction vector is defined by the following formula:

Edge normal direction vector for the first image

Ĩ=(I_{X}, I_{Y}) [Formula 10]

where I_{X}: where differential value in x-direction for the first image

I_{Y}: differential value in y-direction for the first image

The edge-extracting unit 210 feeds the edge normal direction vector of the first image into the evaluation vector-generating unit 211. The evaluation vector-generating unit 211 provides an evaluation vector of the first image, which is defined by two different formulas that follow:

[Formula 11]

length-normalized vector for the first image

$$\vec{J} = ( {J}_{X} , {J}_{Y} ) = \frac{\vec{I}}{\vert \vec{I} \vert} \qquad [ Formula 12 ]$$

assume that “a” is a threshold value to eliminate small edges, the evaluation vector \vec{K} for the first image is given,

if |\vec{I}|≧a

\vec{K}=(K_{X},K_{Y})=(cos(2δ), sin(2δ))=(2J_{X}²−1,2J_{X}J_{Y})

else

\vec{K}=\vec{0}

The input image-processing unit 21 differs from the template image-processing unit 100 in only one thing. That is, a step of performing normalization through division by “n” is omitted. More specifically, similarly to the template image-processing unit 100, the input image-processing unit 21 practices the evaluation according to the even-numbered double angle, the normalization to a length of unity, and noise deletion.

Subsequent components after the evaluation vector-generating unit 211 are now described. As illustrated in FIG. 3, in the input image-processing unit 21, the orthogonal transforming unit 212 Fourier-transforms the evaluation vector of the first image from the evaluation vector-generating unit 211, thereby feeding the Fourier-transformed evaluation vector into the compressing unit 213.

The compressing unit 213 reduces the Fourier-transformed evaluation vector, thereby feeding the reduced evaluation vector into the integrating unit 22. In this instance, the compressing unit 213 reduces the Fourier-transformed evaluation vector to the same frequency band as that of the compressing unit 104. For example, according to the present embodiment, the lower frequency band is used for both of the x-direction and the y-direction.

Subsequent components after the integrating unit 22 are now described. After the input image-processing unit 21 completes all required operations, the recording unit 20 and the compressing unit 213 feeds one Fourier-transformation value of the evaluation vector of the template image and another Fourier-transformation value of the evaluation vector of the first image into the integrating unit 22.

The integrating unit 22 performs multiplication and addition in accordance with Formula 9, thereby feeding results (a Fourier-transformation value of similarity value “L”) into the inverse orthogonal transforming unit 23.

The inverse orthogonal transforming unit 23 inverse-Fourier-transforms the Fourier-transformation value of similarity value “L”, thereby feeding map “L (x, y) “of similarity value “L” into the similarity value-judging unit 24.

The similarity value-judging unit 24 compares each similarity value “L” in map “L” (x, y) with a reference value, thereby allowing a pattern of similarity values “L” that exceed the reference value to be viewed as an object.

The similarity value-judging unit 24 provides information on a position (coordinate) and sizes of the object.

In the detection of an object in an intra-coded picture (I-picture), when the object detection ends in failure because each similarity value “L” is smaller than the reference value, then the object-detecting unit 2 employs results from detection of an object in at least one frame behind. However, such employable results are not limited to the results from the detection of the object in one frame behind.

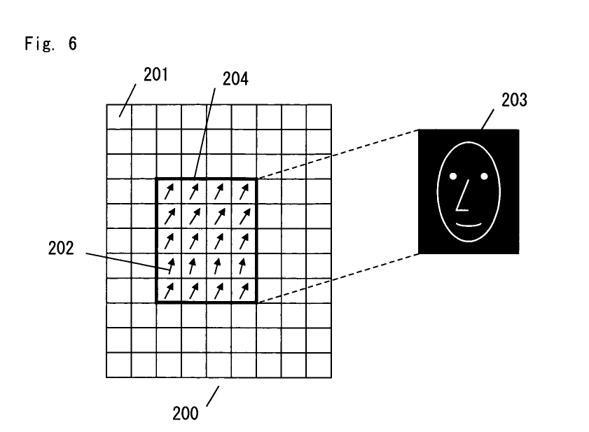

The object domain-tacking unit 3 is now described with reference to FIGS. 1 and 6.

The object domain-tacking unit 3 tracks an object domain in accordance with two different pieces of information: information on a position and sizes of the object detected by the object-detecting unit 2 using the template-matching method; and, motion vector information from the decoding unit 1. Further details of object domain tracking are provided below.

On the assumption that the object domain-tacking unit 3 tracks an object in an either P-picture or B-picture frame, the motion vector information includes a forward predictive motion vector for the P-picture and a bi-directionally predictive motion vector for the B-picture.

In this instance, the motion vector-saving unit 30 saves a piece of motion vector information for each frame.

The object-detecting unit 2 provides information on a position and sizes of an object to be tracked.

The displacement amount-calculating unit 31 tracks the motion of an object domain in accordance with motion vector information that is included in the object domain. The motion vector information is based on the above-mentioned positional and size information from the object-detecting unit 2.

The way of tracking the object domain is now described with reference to a specific example.

FIG. 6 illustrates a frame image 200, on which the following elements are present: macro blocks 201 or a basic unit of encoding; a motion vector 202 determined for each of the macro blocks 201; a facial object 203; and an object domain 204.

The object-detecting unit 2 of FIG. 1 detects the facial object 203, thereby feeding information on a position and sizes (coordinate data and a domain size) of the object domain 204 into the object domain-tacking unit 3.

The displacement amount-calculating unit 31 calculates a motion vector median value or average value using the motion vectors 202 that are possessed by the macro blocks 201 inside the object domain 204.

Assume that the calculated value is a motion quantity of the object domain 204. This premise determines how much an object positioned in a previous frame has been displaced. In this way, the motion of the object domain 204 is tracked.

The object-detecting method-selecting unit 4 of FIG. 1 is now described.

The object-detecting method-selecting unit 4 determines which one of the object-detecting unit 2 and the object domain-tacking unit 3 feeds information on an object position into the image-editing/composing unit 6. The following discusses further details.

The decoding unit 1 feeds compressed and encoded information on a frame type into the object-detecting method-selecting unit 4 at the frame type-judging unit 40. The frame type-judging unit 40 provides such frame type information to the detection method-selecting unit 43.

The detection method-selecting unit 43 selects either the object-detecting unit 2 or the object domain-tacking unit 3 in accordance with the frame type information.

Such a selection made by the detection method-selecting unit 43 is now described with reference to a specific example.

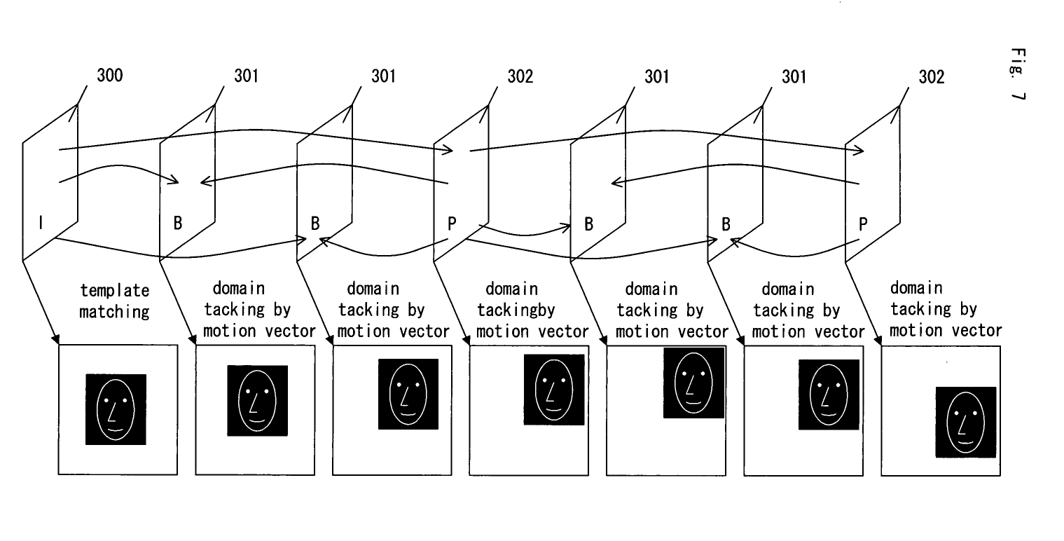

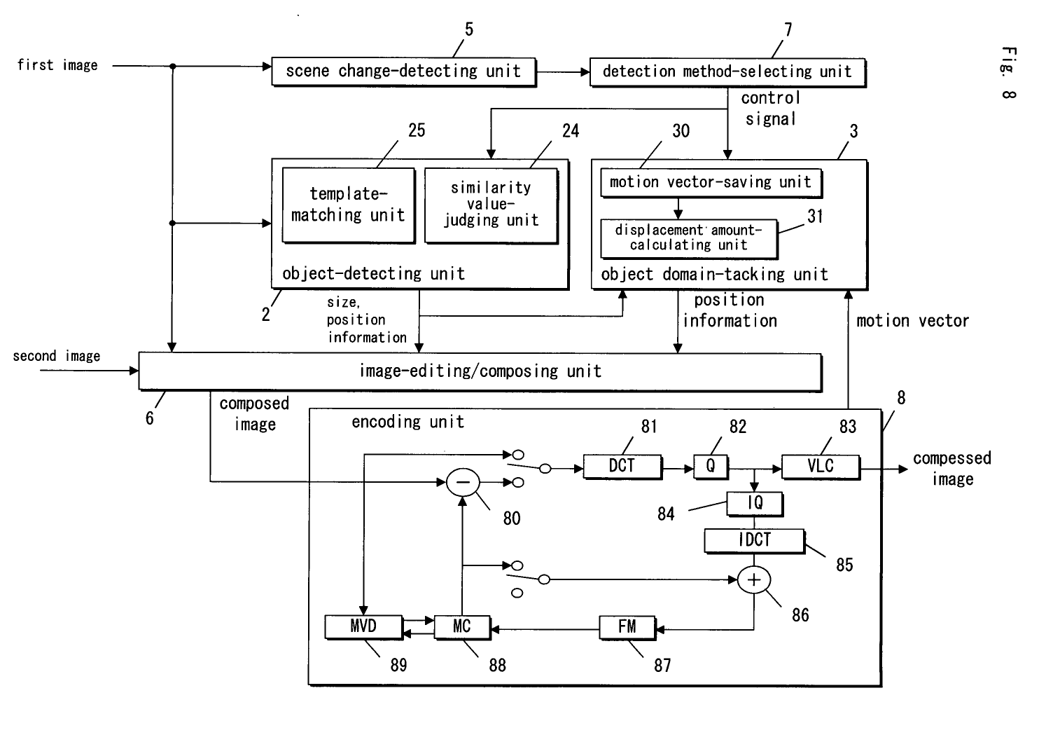

FIG. 7 is an illustration showing, by way of an example, how the detection method-selecting unit 43 makes a selection.

FIG. 7 illustrates an array of image planes (frame images) within GOP (Group of Picture).

In GOP, there are present an intra-coded picture (I-picture) 300, a forward predictive picture (P-picture) 302, and a bi-directionally predictive picture (B-picture) 301.

In this circumstance, motion vectors are present in only the inter-frame predictive P-picture 302 and B-picture 301.

As illustrated in FIG. 7, the detection method-selecting unit 43 selects template matching-based object detection for the I-picture 300, but selects motion vector-based domain tacking for either the P-picture 302 or the B-picture 301.

In brief, the detection method-selecting unit 43 selects the object-detecting unit 2 for the I-picture 300, but selects the object domain-tacking unit 3 for either the P-picture 302 or the B-picture 301.

The frame number-counting unit 42 counts the number of frames in which the object domain has been tracked based on the moving vectors. When the number of the frames is greater than a reference frame number, then the frame number-counting unit 42 advises the detection method-selecting unit 43 to the effect.

The detection method-selecting unit 43 in receipt of the advice from the frame number-counting unit 42 selects the template matching-based object detection.

This means that detection method-selecting unit 43 selects the object-detecting unit 2 upon receipt of such an advice from the frame number-counting unit 42.

In this way, the detection method-selecting unit 43 selects the template matching-based object detection at definite time intervals.

The object domain-tacking unit 3 tracks an object domain in accordance with motion vector information. As a result, when a large number of frames to be tracked extends, then the object domain is displaced because of an accumulated motion vector error.

In order to overcome such shortcomings, the number of frames in which the object domain-tacking unit 3 has tracked the object domain is counted to switch over to the template matching-based object detection at definite time intervals. As a result, the accumulated motion vector error is cancelled.

As described above, when the detection method-selecting unit 43 selects the object-detecting unit 2, then the object-detecting unit 2 detects an object in response to a control signal from the detection method-selecting unit 43, thereby feeding information on a position and sizes of the detected object into the image-editing/composing unit 6.

When the detection method-selecting unit 43 selects the object domain-tacking unit 3, then the object domain-tacking unit 3 tracks an object in response to a control signal from the detection method-selecting unit 43, thereby feeding information on a position of the tracked object into the image-editing/composing unit 6.

The image-editing/composing unit 6 of FIG. 1 is now described.

The image-editing/composing unit 6 edits, more specifically, enlarges, reduces, or rotates a decoded first image in accordance with entering information on an object position. The decoded first image is delivered to the image-editing/composing unit 6 through the decoding unit 1. The image-editing/composing unit 6 composes the edited first image with a second image. Alternatively, the image-editing/composing unit 6 may utilize entering information on object sizes in the editing and composing steps as discussed above.

Assume that the first image is an image including a human facial object, and that the second image is a graphics object. In this instance, either the object-detecting unit 2 or the object domain-tacking unit 3 feeds information on a position of the facial object into the image-editing/composing unit 6. The image-editing/composing unit 6 places the facial object on a display image plane at a central portion thereof, and allows the graphics object to surround the facial object. Alternatively, the image-editing/composing unit 6 can avoid overlapping the graphics object on the facial object.

In conclusion, pursuant to the present embodiment, an amount of displacement of an object is determined based on motion vector information, and the object can be tracked.

This feature eliminates template matching-based object detection when it comes to a motion vector information-containing image (first image) subject to object detection.

As a result, object detection is attainable with a less amount of processing, when compared with the template matching-based detection of objects in all images (first images) subject to object detection.

Pursuant to the present embodiment, when the number of frames in which an object has been tracked in accordance with motion vector information is greater than a reference frame number, then the object is detected in accordance with a template-matching method.

This feature resets an accumulated error due to motion vector information-based object tacking, and provides improved accuracy of detection.

Pursuant to the present embodiment, when a similarity value is smaller than a reference value in the detection of an object in an intra-coded picture (I-picture), then results from the detection of another object in at least one frame behind are employed.

This feature makes it feasible to predict an object position, even with a failure in template matching-based object detection.

According to the present embodiment, a first image is edited based on information on an object position before the first image is composed with a second image.

This feature edits an object to be detected (e.g., the centering of the object), even when the object is displaced from the center of the first image. Consequently, the edited first image is successfully composed with the second image.

In the present embodiment, only two different images, i.e., the first and second images enter the image processor according to the present invention. However, the number of images to enter the same image processor is not limited thereto, but may be three or greater.

(Second Embodiment)

FIG. 8 is a block diagram illustrating an image processor according to a second embodiment. In FIG. 8, components similar to those in FIG. 1 are identified by the same reference numerals, and descriptions related thereto are omitted.

The image processor as illustrated in FIG. 8 includes an object-detecting unit 2, an object domain-tacking unit 3, an image-editing/composing unit 6, a scene change-detecting unit 5, a detection method-selecting unit 7, and an encoding unit 8.

The encoding unit 8 includes a subtracting unit 80, a discrete cosine-transforming unit (DCT) 81, a qunatizing unit (Q) 82, a variable length-coding unit (VLC) 83, an inverse quantizing unit (IQ) 84, an inverse discrete cosine-transforming unit (IDCT) 85, an adding unit 86, a frame memory (FM) 87, a motion-compensating unit (MC) 88, and a motion vector-detecting unit (MVD) 89.

Behaviors of the above components are now described.

The scene change-detecting unit 5 detects a scene change in a first image that has entered the image processor.

The detection method-selecting unit 7 selects an object-detecting method in accordance with results from the detection by the scene change-detecting unit 5.

More specifically, when the scene change-detecting unit 5 detects a scene change, then the detection method-selecting unit 7 selects template matching-based object detection, i.e., the object-detecting unit 2.

When the scene change-detecting unit 5 detects no scene change, then the detection method-selecting unit 7 selects motion vector-based object tacking, i.e., the object domain-tacking unit 3.

The object-detecting unit 2 detects an object in accordance with a template-matching method, and then feeds information on a position and sizes of the detected object into the image-editing/composing unit 6.

When the detection method-selecting unit 7 selects the object-detecting unit 2, then the object-detecting unit 2 detects the object in a way as discussed above upon receipt of a control signal from the detection method-selecting unit 7.

The object domain-tacking unit 3 tracks an object domain in accordance with motion vector information from the encoding unit 8, and then feeds information on a position of the tracked object domain into the image-editing/composing unit 6.

When the detection method-selecting unit 7 selects the object domain-tacking unit 3, then the object domain-tacking unit 3 tracks the object domain in a manner as discussed above upon receipt of a control signal from the detection method-selecting unit 7.

The object domain-tacking unit 3 according to the present embodiment is substantially similar to an object domain-tacking unit 3 according to the previous embodiment except for one thing. That is, the former object domain-tacking unit 3 tracks the object domain in accordance with the motion vector information from the encoding unit 8, but the latter does the same in accordance with motion vector information from a decoding unit 1.

The image-editing/composing unit 6 edits a first image in accordance with the information on the position of the object, and then composes the edited first image with a second image, thereby producing a composed image. Alternatively, the image-editing/composing unit 6 may use the size information of the object in the above editing and composing steps.

The encoding unit 8 encodes and compresses the composed image from the image-editing/composing unit 6.

The following discusses such encoding and compressing steps more specifically.

An intra-encoding mode is now discussed. The composed image from the image-editing/composing unit 6 enters the discrete cosine-transforming unit 81.

The discrete cosine-transforming unit 81 practices the discrete cosine transformation of the entering composed image, thereby creating a DCT coefficient.

The quantizing unit 82 quantizes the DCT coefficient, thereby generating a quantized DCT coefficient.

The variable length-coding unit 83 executes the variable length coding of the quantized DCT coefficient, thereby generating encoded data (compressed image data).

At the same time, the quantized DCT coefficient enters the inverse quantizing unit 84 from the quantizing unit 82.

The inverse quantizing unit 84 inverse-quantizes the quantized DCT coefficient, thereby providing a DCT coefficient.

The inverse discrete cosine-transforming unit 85 executes the inverse discrete cosine transformation of the DCT coefficient, thereby providing a composed image.

The frame memory 87 stores the composed image as a reference image.

A motion-compensating prediction mode is now described. The composed image enters the subtracting unit 80 from the image-editing/composing unit 6.

The subtracting unit 80 determines a difference between the entering composed image and a predictive image determined by the motion-compensating unit 88. As a result, the subtracting unit 80 provides a predictive error image.

The discrete cosine-transforming unit 81 performs the discrete cosine transformation of the predictive error image, thereby determining a DCT coefficient.

The quantizing unit 82 quantizes the DCT coefficient, thereby determining a quantized DCT coefficient.

The variable length-coding unit 83 executes the variable length coding of the quantized DCT coefficient, thereby providing encoded data (compressed image data).

At the same time, the quantized DCT coefficient enters the inverse quantizing unit 84 from the quantizing unit 82.

The inverse quantizing unit 84 inverse-quantizes the quantized DCT coefficient, thereby providing a DCT coefficient.

The inverse discrete cosine-transforming unit 85 executes the inverse discrete cosine transformation of the DCT coefficient, thereby providing a predictive error image.

The adding unit 86 adds the predictive error image from the inverse discrete cosine-transforming unit 85 to the predictive image from the motion-compensating unit 88, thereby creating a reference image.

The frame memory 87 stores the reference image.

The motion vector-detecting unit 89 detects a motion vector using both of the composed image to be encoded, and the reference image.

The motion-compensating unit 88 creates a predictive image using both of the motion vector detected by the motion vector-detecting unit 89, and the reference image stored in the frame memory 87.

Steps according to the present embodiment are now described with reference to a specific example.

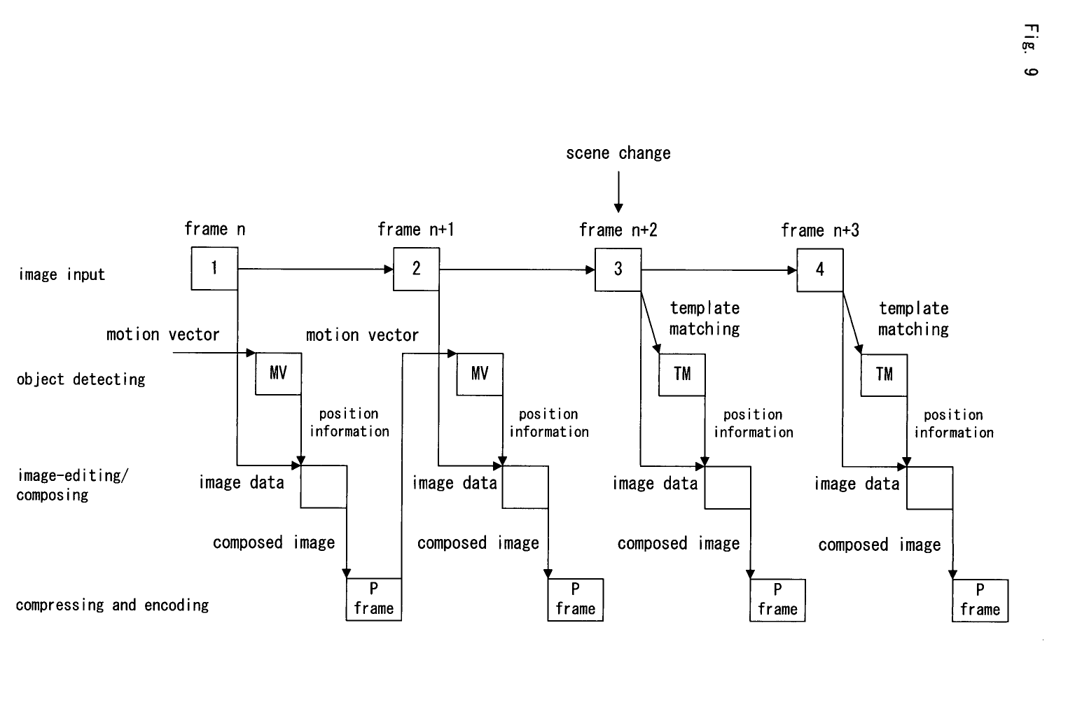

FIG. 9 is an illustration showing, as an example, how the image processor according to the present embodiment deals with the steps.

FIG. 9 shows a flow of processing as an illustration, such as image input, object detection, image editing and image composition, and image compression and encoding. The image input refers to the input of a first image.

As illustrated in FIG. 9, for a frame “n” (“n” is a natural number), motion vector information predicted based on a frame “n−1” is available; for a frame “n+1”, motion vector information predicted based on the frame “n” is available.

The object domain-tacking unit 3 tracks an object domain in the frame “n” using the motion vector information predicted based on the frame “n−1”.

The image-editing/composing unit 6 edits the frame “n” in accordance with information on a position of a tracked object from the object domain-tacking unit 3. The image-editing/composing unit 6 composes the edited image with a second image, thereby producing a composed image.

Similarly, the object domain-tacking unit 3 tracks an object domain in the frame “n+1” using the motion vector information predicted based on the frame “n”; the image-editing/composing unit 6 edits the frame “n+1”, and then composes the edited image with a second image, thereby producing a composed image.

When a frame “n+2” changes a scene, then the scene change-detecting unit 5 checks on such a change. Subsequently, the detection method-selecting unit 7 selects the object-selecting unit 2.

The object-detecting unit 2 compares the frame “n+2” with a template image. The object-detecting unit 2 views a pattern having a similarity value greater than a reference value as an object, and provides a position and size of the object.

The image-editing/composing unit 6 edits the frame “n+2” in accordance with the information on a position of the object from the object-detecting unit 2. The image-editing/composing unit 6 composes the edited image with a second image, thereby producing a composed image.

As described above, according to the present embodiment, an amount of displacement of an object is determined in accordance with motion vector information, and the object can be tracked.

This feature eliminates template matching-based object detection when it comes to a motion vector information-containing image (first image) subject to object detection.

As a result, object detection is achievable with a less amount of processing, when compared with the template matching-based detection of objects in all images (first images) subject to object detection.

Pursuant to the present embodiment, when a similarity value is smaller than a reference value in the detection of an object in an intra-coded picture (I-picture), then results from the detection of another object in at least one frame behind are employed.

This feature makes it feasible to predict an object position, even with a failure in template matching-based object detection.

According to the present embodiment, a first image is edited based on information on an object position before the first image is composed with a second image.

This feature edits an object to be detected (e.g., the centering of the object), even when the object is displaced from the center of the first image. Consequently, the edited first image is successfully composed with the second image.

According to the present embodiment, object detection is realized using a template-matching method when it comes to an image (first image) subject to object detection in which a scene is changed.

This feature makes it feasible to detect an object in an I-picture containing no motion vector.

In the present embodiment, only two different images, i.e., the first and second images enter the image processor according to the present invention. However, the number of images to enter the same image processor is not limited thereto, but may be three or greater.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An image-processing method designed for object detection in a moving image, comprising
detecting an object by matching a template image with an image subject to object detection; and
determining an amount of displacement of the detected object in accordance with information on a motion vector of an encoded moving image, the detected object being the object detected by said detecting the object by matching the template image with the image subject to object detection.

2. The image-processing method as defined in claim 1, wherein an object in an intra-coded picture (I-picture) is detected by said detecting the object by matching the template image with the image subject to object detection,
wherein an object in a forward predictive picture (P-picture) is detected by said determining the amount of displacement of the detected object in accordance with information on the motion vector of the encoded moving image, the detected object being the object detected by said detecting the object by matching the template image with the image subject to object detection, and
wherein an object in a bi-directionally predictive picture (B-picture) is detected by said determining the amount of displacement of the detected object in accordance with information on the motion vector of the encoded moving image, the detected object being the object detected by said detecting the object by matching the template image with the image subject to object detection.

3. The image-processing method as defined in claim 1, further comprising:
counting number of frames in which an object is tracked by said determining the amount of displacement of the detected object in accordance with information on the motion vector of the encoded moving image, the detected object being the object detected by said detecting the object by matching the template image with the image subject to object detection; and
comparing a reference frame number with the number of the frames counted by said counting the number of the frames in which the object is tracked,
wherein, when the number of the frames counted by said counting the number of the frames in which the object is tracked is greater than the reference frame number, then object detection is performed by said detecting the object by matching the template image with the image subject to object detection.

4. The image-processing method as defined in claim 1, wherein said detecting the object by matching the template image with the image subject to object detection comprises:
comparing a reference value with a similarity value between the template image and the image subject to object detection; and
employing results from detection of an object in at least one frame behind when the similarity value is smaller than the reference value, in order to practice object detection in an intra-coded picture (I-picture).

5. The image-processing method as defined in claim 1, further comprising:
decoding an encoded moving image, thereby generating the image subject to object detection;
editing the image subject to object detection as a first image; and
composing the edited first image with a second image, thereby producing a composed image,
wherein said detecting the object by matching the template image with the image subject to object detection includes providing information on a position of a detected object,
wherein said determining the amount of displacement of the detected object in accordance with information on the motion vector of the encoded moving image, the detected object being the object detected by said detecting the object by matching the template image with the image subject to object detection includes providing information on a position of a displaced object, and
wherein said editing the image subject to object detection as the first image includes editing the first image in accordance with the information on the position.

6. The image-processing method as defined in claim 1, further comprising:
detecting a scene change in the image subject to object detection,
wherein an object in the image subject to object detection in which a scene has been changed is detected by said detecting the object by matching the template image with the image subject to object detection.

7. An image-processing method comprising:
detecting any object in a moving image;
editing said moving image in accordance with information on a position of said detected object;
composing the edited moving image with another moving image; and
encoding and compressing the composed image.

8. The image-processing method as defined in claim 1, wherein the object to be detected is a human face.

9. The image-processing method as defined in claim 1, wherein said detecting the object by matching the template image with the image subject to object detection and said determining the amount of displacement of the detected object in accordance with information on the motion vector of the encoded moving image, the detected object being the object detected by said detecting the object by matching the template image with the image subject to object detection, can be switched over therebetween.

10. An image processor designed for object detection in a moving image, comprising:
an object-detecting unit operable to detect an object by matching a template image with an image subject to object detection; and
an displacement amount-detecting unit operable to determine an amount of displacement of the detected object in accordance with information on a motion vector of an encoded moving image, the detected object being the object detected by said object-detecting unit.
